(19) United States
(12) Patent Application Publication
(10) Pub. No.: US 2017/0156055 A1
(43) Pub. Date: Jun. 1, 2017

(54) PRIVACY ISSUES IN M2M

(71) Applicant: NEC Corporation, Tokyo (JP)

(72) Inventors: Xiaowei ZHANG, Tokyo (JP); Anand Raghawa PRASAD, Tokyo (JP)

(21) Appl. No.: 15/373,402

(22) Filed: Dec. 8, 2016

Related U.S. Application Data
(63) Continuation of application No. 14/372,885, filed on Jul. 17, 2014.

(30) Foreign Application Priority Data
Jan. 27, 2012 (JP) 2012-015576

(51) Int. Cl. H04W 12/02; H04W 12/06; H04W 4/22; H04W 4/02; H04W 76/00; H04L 29/06; H04W 4/00

(52) U.S. Cl. CPC H04W 12/02; H04L 63/04; H04W 12/06; H04W 4/005; H04W 4/02; H04W 76/007; H04W 4/22

(57) ABSTRACT

Upon transmitting privacy information to an MTC server (20) via a network (30, 40), an MTC device (10) includes in a message a field to indicate whether the message contains the privacy information, such that the network (30, 40) can perform authorization for the MTC device (10) and server (20). When the MTC device (10) needs to keep connection with the network (30, 40), the MTC device (10) switches off the functionality of provisioning the privacy information, such that the MTC device (10) still can communicate with the network (30, 40). Upon the transmission of privacy information in an emergency case, the MTC device (10) further includes in the message a content to indicate that the MTC device (10) is an emergency device, such that the network (30, 40) verifies whether the MTC device (10) can be used or activated in the emergency case. Optionally, a USIM for emergency-use is deployed in the MTC device (10).

### TECHNICAL FIELD

The present invention relates to security and privacy issue in machine-to-machine communication (M2M).

### BACKGROUND ART

Privacy issue has been considered in 3GPP (Third Generation Partnership Project). NPL 3 discloses “Privacy breach due to (unnecessary) collection of location information of an MTC (Machine-Type-Communication) Device that can be linked to an individual” (see Clause 5.7.2).

The requirement described in NPL 3 is “It should be possible to prevent tracking of location information for some types of MTC Device” (see Clause 5.73).

Therefore a mechanism of securely providing location information from MTC device to network and MTC server is necessary in M2M system.

Note that service requirements and system improvements for MTC are disclosed by NPL 1 and 2, respectively.

### CITATION LIST

### Non Patent Literature

NPL 1: 3GPP TR 22.368, “Service requirements for Machine-Type Communications (MTC); (Release 11)”, V11.3.0, 2011-09, clause 7.2.11, pp. 16-17
NPL 2: 3GPP TR 23.888, “System Improvements for Machine-Type Communications; (Release 11)”, V1.5.0, 2011-10, clause 4, pp. 7-17
NPL 3: 3GPP TR 33.868, “Security aspects of Machine-Type Communications (Release 11)”, V0.6.0, 2011-11, clauses 5.7 and 7.6, pp. 17-18 and 29

### SUMMARY OF INVENTION

As location information is important and related to privacy, it should only be provided securely to authenticated and authorized MTC server when it is necessary.

The issue can be broken down as below:

[1]. Location information should not be exposed to unauthorized MTC server to prevent attack.

[2]. MTC device can provide location information according to network and/or MTC server request.

[3]. Unnecessary location information should not be sent especially continuously to create more traffic load.

[4]. Location information should be available and secured in emergency case.

NPL 3 has not provided any solution for the above mentioned issues. To achieve them, interfaces T5a/T5b and MTCsp should be enhanced.

In this invention, privacy data is considered with focus on location information as described in NPL 3. The invention is applicable for other privacy data as well.

It is described in NPL 3 that MTC Devices may be detached from the network when not communicating to prevent unnecessary collection of location information by the network. However, MTC device may need keep connected and cannot be detached only for location information purpose.

It is also proposed in NPL 3 that “The MTC Device may need to provide an ability to transmit location tracking information in emergency case”. To which a solution is provided in this invention.

### Advantageous Effects of Invention

According to the present invention, it is possible to achieve at least one of the following effects 1 to 4.

1. Location information is only provided to authorized MTC server from a MTC device with the feature, when it is necessary according to network and/or MTC server requirement.

2. Location information is protected while being sent to network and MTC server to prevent attack.

3. Location information provision function can be switched-off so that unnecessary location information will not be provided; MTC device can still connect to network; reduce traffic load.

4. Location information can be securely provided in emergency case.

### BRIEF DESCRIPTION OF DRAWINGS

FIG. 1 is a block diagram showing a configuration example of a system according to an exemplary embodiment of the present invention.

FIG. 2 is a sequence diagram showing an operation example of a system according to an exemplary embodiment of the present invention.

FIG. 3 is a block diagram showing a configuration example of an MTC device according to an exemplary embodiment of the present invention.

FIG. 4 is a block diagram showing a configuration example of a node according to an exemplary embodiment of the present invention.

### DESCRIPTION OF EMBODIMENTS

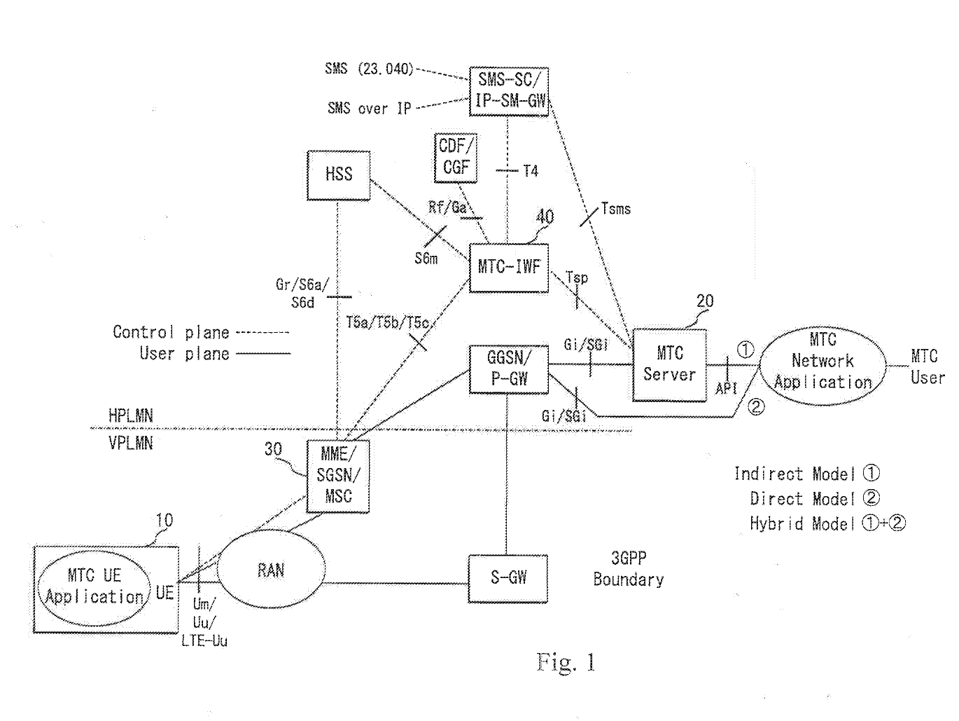

Hereinafter, an exemplary embodiment of the present invention will be described with reference to FIGS. 1 to 4.

As shown in FIG. 1, a system according to this exemplary embodiment includes a UE (User Equipment) serving as an MTC device 10, a network, and an MTC server 20. The MTC device 10 is connected to the network via a RAN (Radio Access Network). The network includes an MME (Mobility Management Entity) 30, an HSS (Home Subscriber Server), an MTC-IWF (Interworking Function) 40, S-GW (Serving Gateway), P-GW (PDN (Packet Data Network) Gateway), and the like. The MME 30 is connected to the MTC server 20 via the MTC IWF 40 or S-GW/P-GW.

The inventors of this application have found that in such a system, there are the following threats regarding privacy issue.

### <Threats>

Privacy breach due to (unnecessary) collection of location information of an MTC Device that can be linked to an individual.

Privacy sensitive information sent by a MTC device which is not allowed to do so, or towards a MTC server which is not allowed to receive it. Note that in the context of MTC, identity information and location information can be considered as privacy sensitive information.

In order to address these threats, the following security requirements apply.

### <Security Requirements>

Network should be able to verify whether a message contains any privacy sensitive information.
Network should be able to perform access control for MTC device which is sending privacy sensitive information and MTC server which requests and is receiving the privacy information.
Privacy sensitive information transmitted to MTC server via network should be protected.

There are described solutions which meet these security requirements.

### <Solutions>

When the MTC device needs to connect with network, it should be able to switch-off the functionality of provisioning location information, such that it still can communicate with the network.

A field should be added in a given message to indicate whether the message contains privacy sensitive information, such that the network can verify.

Further, in order to achieve privacy issues in emergency case, the following security requirements may apply.

### <Security Requirements Regarding Privacy Issues in Emergency Case>

MTC device should be able to securely provide location information and other privacy sensitive information in emergency case.
Network should be able to perform access control of MTC device which is sending privacy sensitive information in emergency message.

There are described solutions which meet these security requirements.

### <Solutions for Emergency Case>

A field can be added in a given emergency message to indicate whether it is an emergency-use MTC device. Network verifies whether the MTC device can be used/activated in emergency case.

Security protection can be provided by NAS security context if they are valid, or an optional solution is to deploy an emergency-use USIM in MTC device.

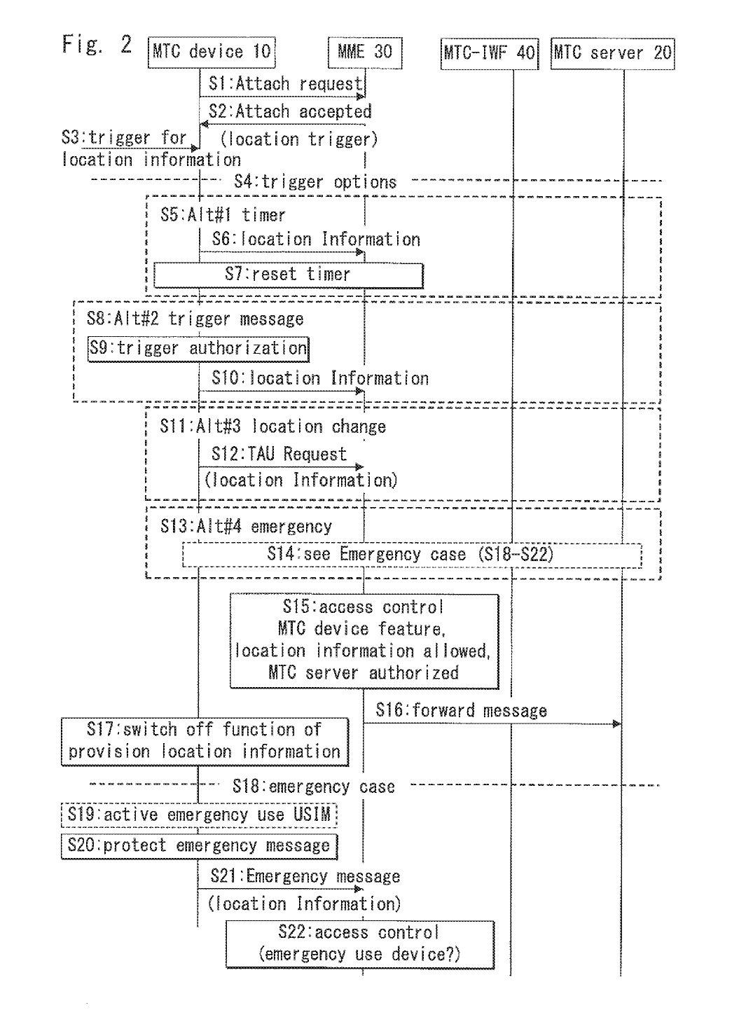

Next, there will be described details of the above-mentioned solutions with reference to FIG. 2.

A few assumptions are made as below:

i. Network and MTC server 20 has mutual authentication;

ii. MTC device 10 and network has mutual authentication;

iii. MTC device 10 and MTC server 20 has mutual authentication.

Network should be aware of location information is being sent to MTC server, and it should perform authorization to verify if the information can be sent to a specific MTC server.

Operations to achieve the above-mentioned issue [1] (Location information should not be exposed to unauthorized MTC server to prevent attack) are as follows.
a) Special field to indicate that the message includes location information is used in b) to d) below.
b) The location information should be protected by secure communication between MTC device 10 and MTC server 20.
c) Network performs authorization for MTC device 10 (Step S15), by verifying:
   (c1) whether the MTC device 10 has the feature of providing location information;
   (c2) whether the MTC device 10 is allowed to send the location information to the given MTC server 20.
d) Network performs authorization for MTC server 20 (Step S15), by verifying:
   (d1) whether MTC server 20 is allowed to request location information from the given MTC device 10.

Operations to achieve the above-mentioned issue [2] (MTC device can provide location information according to network and/or MTC server request) are as follows.
a) In Attach procedure, MTC device 10 is given location information related parameter such as allowed MTC server, functionality switch on/off (Steps S1 and S2). And it should send location information every time soon after it is attached to the network (Steps S3 to S14). It is the same for TAU (Tracking Area Update).
b) The MTC device 10 can be triggered to send location information with:
   (b1) Timer for location report (which can be periodic, or fixed time for next time only) (Steps SS to S7);
   (b2) Trigger message from authorized MTC server 20 with a request (Steps S8 to S10);
   (b3) Emergency case (Steps S13 and S14); or
   (b4) Location change, depend on the agreement with network/MTC server 20. This can be in TAU procedure (Steps S11 and S12).

Operations to achieve the above-mentioned issue [3] (Unnecessary location information should not be sent especially continuously to prevent network load) are as follows.
a) MTC device 10 should be able to switch off the functionality to provide location information, to be tracked or monitored, while MTC device 10 needs to be connected to the network for other communication (Step S17).
b) The switch off timing can be indicated by the MTC server 20 when it is necessary or dependent on a configured condition, e.g. event trigger of every time after the location information is provided.

Operations to achieve the above-mentioned issue [4] (Location information should be available and secured in emergency case) are as follows.
a) On emergency (Step S18), the MTC Device 10 starts communication via MME 30 thus sending control message to MTC server 20 (Step S21).
b) MME 30 can identify that the MTC device 10 is an emergency device due to special field in IMEI (International Mobile Equipment Identity) (Step S22). MME 30 can be informed by HSS that the MTC device/UE is an emergency device. There could be other ways to identify a device as a MTC device, e.g. a new field in the packet sent from the MTC device 10.
c) MME 30 signals b) to MTC Server 20 via the MTC IWF 40 or S-GW/P-GW.
d) Deploy unique emergency USIMs (Universal Subscriber Identity Modules). This can be done by registering USIMs sold to e.g. car companies as emergency MTC USIMs or simple having special USIMs with special IMSI (International Mobile Subscriber Identity) that relate to emergency MTC devices.
e) Security of the privacy data (location information) transmission can be transmitted (Step S20), in one of the following ways:
   (e1) The emergency-use USIM can provide security context to protect privacy data (location information) (Step S19);
   (e2) NAS (Non-Access Stratum) security between MTC device 10 and MME 30 followed by security between MTC IWF 40 and MTC server 20; or
   (e3) End-to-end security between MTC device 10 and MTC server 20.
f) Emergency content of the message could be the novel part: MTC device identifier indicating it is an emergency device, -- message path: MTC device 10→MME 30→MTC IWF 40→MTC Server 20.

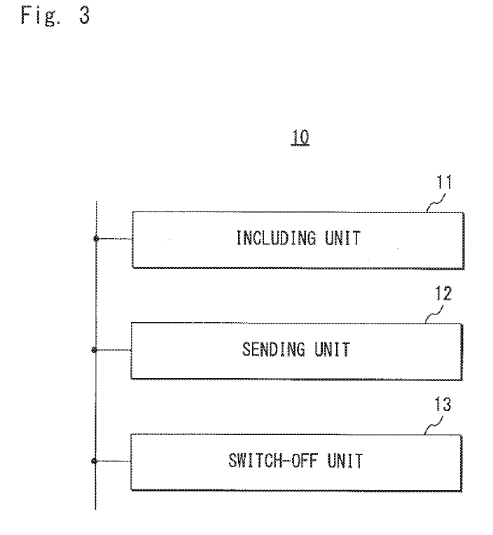

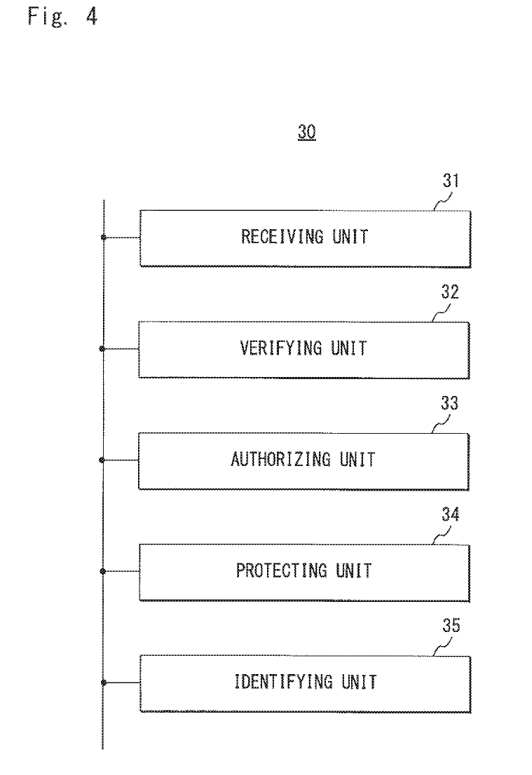

Next, configuration examples of the MTC device 10 and the MME 30 according to above-mentioned exemplary embodiments will be subsequently described with reference to FIGS. 3 and 4.

As shown in FIG. 3, the MTC device 10 includes an including unit 11, a sending unit 12, and a switch-off unit 13. The including unit 11 includes, in the message, the field mentioned in the operations regarding the issue [1]. The sending unit 12 sends the message to the MTC server 20 through the MME 30, and the MTC-IWF 40 or the S-GW/P-GW. As mentioned in the operations regarding the issue [2], the sending unit 12 may send out the privacy sensitive information by using, as a trigger, expiry of the timer, a trigger message received from the MTC server 20, or change in location of the MTC device. As mentioned in the operations regarding the issue [3], the switch-off unit 13 switches off the functionality to provide the privacy sensitive information, while maintaining the connection with the MME 30, and the MTC-IWF 40 or the S-GW/P-GW. In the emergency case, the including unit 11 includes, in the message or the IMEI in the message, the field mentioned in the operations regarding the issue [4]. At this time, the sending unit 12 may protect the privacy sensitive information with the security context stored in the above-mentioned emergency-use USIM (not shown). Note that the units 11 to 13 are mutually connected with each other thorough a bus or the like. These units 11 to 13 can be configured by, for example, a transceiver which conducts communication with the MME 30 and the like through the RAN, and a controller which controls this transceiver to execute the processes shown in FIG. 2 or processes equivalent thereto.

Further, as shown in FIG. 4, the MME 30, which is one of node forming the network, includes a receiving unit 31, a verifying unit 32, an authorizing unit 33, a protecting unit 34, and an identifying unit 35. The receiving unit 31 receives, from the MTC device 10, the message including the field mentioned in the operations regarding the issue [1]. The verifying unit 32 verifies, based on this field, whether the message contains the privacy sensitive information. The authorizing unit 33 authorizes the MTC device 10 by verifying whether the MTC device 10 is allowed to send the privacy sensitive information to the MTC server 20. Also, the authorizing unit 33 authorizes the MTC server 20 by verifying whether the MTC server 20 is allowed to request or receive the privacy sensitive information from the MTC device 10. The protecting unit 34 securely protects the privacy sensitive information upon transferring the message from the MTC device 10 to the MTC server 20. In the emergency case, the receiving unit 31 receives, from the MTC device 10, the message including the field mentioned in the operations regarding the issue [4]. The identifying unit 35 identifies, based on this field, the MTC device 10 as the emergency device. Note that the units 31 to 35 are mutually connected with each other thorough a bus or the like. These units 31 to 35 can be configured by, for example, a transceiver which conducts communication with the MTC device 10 through the RAN, a transceiver which conducts communication with the MTC server 20 through the MTC-IWF 40 or the P-GW, and a controller which controls these transceivers to execute the processes shown in FIG. 2 or processes equivalent thereto.

Note that the present invention is not limited to the above-mentioned exemplary embodiment, and it is obvious that various modifications can be made by those of ordinary skill in the art based on the recitation of the claims.

This application is based upon and claims the benefit of priority from Japanese patent application No. 2012-015576, filed on Jan. 27, 2012, the disclosure of which is incorporated herein in its entirety by reference.

The whole or part of the exemplary embodiments disclosed above can be described as, but not limited to, the following supplementary notes.

(Supplementary Note 1)

Special field to indicate the message includes privacy data (i.e., location information).

(Supplementary Note 2)

Special field to indicate the MTC device can active in emergency.

(Supplementary Note 3)

Access control for MTC device which intends to provide privacy data to a given MTC server.

(Supplementary Note 4)

Access control for MTC server which intends to request privacy data to a given MTC device.

(Supplementary Note 5)

Trigger to request MTC device providing location information or other privacy sensitive information according to network and/or MTC server requirement, can be timer, trigger message, location change.

(Supplementary Note 6)

Privacy data including location information can be securely provided in emergency case.

(Supplementary Note 7)

Secure communication between MTC device and MTC server is provided, options are unique USIM for emergency use; NAS security followed by security between MTC IWF and MTC server; end-to-end security between MTC device and MTC server.

(Supplementary Note 8)

MTC device can switch-off the functionality which sends location information, e.g., location report, monitoring, tracking while the MTC device can still be connected to network.

(Supplementary Note 9)

Emergency content in the message indicates it is an emergency use MTC device.

### REFERENCE SIGNS LIST

10 MTC DEVICE
11 INCLUDING UNIT
12 SENDING UNIT
13 SWITCH-OFF UNIT
20 MTC SERVER
30 MME
31 RECEIVING UNIT
32 VERIFYING UNIT
33 AUTHORIZING UNIT
34 PROTECTING UNIT
35 IDENTIFYING UNIT
40 MTC-IWF

1.-33. (canceled)

34. A terminal, comprising:
a controller configured to serve as an MTC (Machine-Type-Communication) device in an M2M (Machine-to-Machine) communication system which includes an MTC sever and a network including an MME (Mobility Management Entity) or an SGSN, and an MTC-IWF (Machine Type Communication Interworking Function); and
a receiver configured to receive a trigger request from the MTC server which is authorized to send the request by the network;
wherein the network monitors a location information of the MTC device in response to a change of location of the MTC device according to the request of the network.

35. The terminal according to claim 34, the MTC server connects to a communication partner of the terminal.

36. A communication method of a terminal, comprising:
serving as an MTC (Machine-Type-Communication) device in an M2M (Machine-to-Machine) communication system which includes an MTC sever and a network including a network including an MME (Mobility Management Entity) or an SGSN, and an MTC-IWF (Machine Type Communication Interworking Function); and
receiving a trigger request from the MTC server which is authorized to send the request by the network;
wherein the network monitors a location information of the MTC device in response to a change of location of the MTC device according to the request of the network.

37. The method according to claim 36, the MTC server connects to a communication partner of the terminal.

38. A network in an M2M (Machine-to-Machine) communication system which includes a terminal serving as an MTC (Machine-Type-Communication) device and an MTC sever, comprising:
an MME (Mobility Management Entity) or an SGSN; and
an MTC-IWF (Machine Type Communication Interworking Function);
wherein the network authorizes the MTC server to send a trigger request to the MTC device and monitors a location information of the MTC device in response to a change of location of the MTC device according to the request of the network.

39. The network according to claim 38, the MTC server connects to a communication partner of the terminal.

40. A communication method of a network including an MME (Mobility Management Entity) or an SGSN and an MTC-IWF (Machine Type Communication Interworking Function) in an M2M (Machine-to-Machine) communication system which includes a terminal serving as an MTC (Machine-Type-Communication) device and an MTC sever, comprising:
authorizing the MTC server to send a trigger request to the MTC device; and
monitoring a location information of the MTC device in response to a change of location of the MTC device according to the request of the network.

41. The method according to claim 40, the MTC server connects to a communication partner of the terminal.
